(19) United States
(12) Patent Application Publication
(10) Pub. No.: US 2012/0301848 A1
(43) Pub. Date: Nov. 29, 2012

(54) Dental Composite Packing Instrument

(76) Inventor: Joseph P. O'Donnell, Bedford, MA (US)

(21) Appl. No.: 13/469,418

(22) Filed: May 11, 2012

Related U.S. Application Data
(60) Provisional application No. 61/486,795, filed on May 17, 2011.

(51) Int. Cl. A61C 3/08

(52) U.S. Cl. 433/164

(57) ABSTRACT

A dental instrument that has a first shaft, and a first operative end that defines a generally flat face. The face has a generally oval shape with opposite narrow ends. The instrument can have two shafts that are each adapted to be coupled to a handle; each shaft has such a flat face. The faces can be perpendicular to each other.

### CROSS-REFERENCE TO RELATED APPLICATION

This application claims priority of Provisional Application Ser. No. 61/486,795 filed on May 17, 2011, the disclosure of which is incorporated herein by reference.

### FIELD

This disclosure relates to a dental instrument.

### BACKGROUND

Condensers are used by dentists to condense restorative dental materials into cavity preparations. Most condensers have ball-shaped tips and are good general-purpose tools. However, since both the face and circumference of the tip are curved, and the curve is uniform, the shape does not correspond well to the interior surfaces of the cavity preparation; the gingival floor and the axial walls of interproximal cavity preparations are relatively flat, and a round tip can touch a flat wall only at a point or line. Even flat-faced condensers usually have a circular face that does not match well with flat walls. The dentist thus must carefully manipulate the condenser tip against and adjacent to the walls of the cavity preparation and the matrix band in order to properly fill the preparation. Round-tipped instruments are thus difficult to use to pack the restorative dental material into an interproximal cavity preparation without leaving voids, open margins or other filling defects.

### SUMMARY

The subject dental composite condensing device/instrument is a hand held and hand-operated dental instrument made of stainless steel or other materials known to be used in dental hand instruments. Dental hand instruments are typically comprised of working or operative ends which are coupled to a variety of standard dental instrument handles, typically by fitting into the handle and then being secured with a set screw or friction fit with or without the use of a cement, or other suitable affixing method. The instrument is preferably but not necessarily double ended. The instrument is designed specifically to condense restorative dental materials such as composite resins and resin-modified glass ionomer materials into interproximal cavity preparations of primary and permanent posterior teeth. The device is designed to condense and pack these materials to be flush with the gingival floor and axial walls of such cavity preparations. The pointed oval shape of the operative end fits the shape created by matrix band, thus eliminating voids or open margins after the material has cured.

This disclosure includes a dental instrument comprising a handle which transitions to one or two working/operative ends, wherein each working end defines a generally flat face having a generally elliptical or pointed oval shape. The instrument may have a generally circular handle or shaft that smoothly transitions to a pointed oval shape with a flat face. The instrument may define two identical ends with the pointed oval shapes perpendicular to each other. The ends are bent at an angle to the handle portion to enable access to cavity preparations. In a double ended instrument, the orientation of the ends would be mirror image along the long axis of the handle portion.

Featured herein is a dental instrument with a first shaft and a first operative end that defines a generally flat face and a relatively narrow portion of the face. The face may have a generally oval shape with opposite narrow ends. The narrow ends of the face may be generally pointed. In a specific example the face is about 2.5 mm long from pointed end to pointed end and is about 1.5 mm wide, and along opposite sides between the pointed ends the perimeter of the face has a radius of curvature of about 1 mm. The first shaft may have a generally circular cross-sectional shape, and there may also be an integral transitional section that smoothly flares outward and transitions into the operative end. The first shaft may be constructed and arranged to be coupled to a handle.

There may also be a second shaft with a second operative end that defines a generally flat face that has a generally oval shape with opposite narrow ends. The first and second operative ends may each define a longitudinal axis, and the narrow ends of each face may lie along these longitudinal axes. The two longitudinal axes may be transverse to each other, and may be perpendicular to each other.

Featured in a more specific example is a dental instrument that is constructed and arranged to be used along with a handle comprising a first shaft that is constructed and arranged to be coupled to a handle and that has a generally circular cross-sectional shape and comprises an integral transitional section that smoothly flares outward and transitions into a first operative end that defines a generally flat first face, wherein the first face has a generally oval shape with opposite narrow ends that are generally pointed, and a second shaft that is constructed and arranged to be coupled to a handle and that has a generally circular cross-sectional shape and comprises an integral transitional section that smoothly flares outward and transitions into a second operative end that defines a generally flat second face, wherein the second face has a generally oval shape with opposite narrow ends that are generally pointed. The first and second operative ends each define a longitudinal axis, the narrow ends of each face lie along these longitudinal axes, and the axes are essentially perpendicular to each other. In a very specific example each face is about 2.5 mm long from pointed end to pointed end and about 1.5 mm wide, and along opposite sides between the pointed ends the perimeter of each face has a radius of curvature of about 1 mm.

### BRIEF DESCRIPTION OF THE DRAWINGS

Examples of the dental instrument are depicted in the drawings, in which:

FIG. 1A is a top view of one operative end of an example of the subject dental instrument.

FIG. 1B is a side view of the example shown in FIG. 1A.

FIG. 1C is an end view of the example shown in FIG. 1A.

FIG. 1D is an end view of a slightly different example.

FIGS. 2A-2D are perspective cross-sectional, end, top cross-sectional and side views, respectively, detailing the shape of the faces of the examples shown in FIGS. 1A-1D.

FIG. 2E illustrates the face of a different example.

FIG. 3A is a partial, highly schematic top view of a tooth with an interproximal cavity preparation, before use of the subject device to condense the material that is used to fill the preparation.

FIG. 3B is a cross-section taken along line 3B-3B of FIG. 3A.

FIG. 3C is a greatly enlarged view of portion “A” of FIG. 3A and showing the face of the instrument in use packing restorative material into the cavity preparation.

FIG. 4 is an exploded view illustrating how an operative end can be coupled to a handle.

FIG. 5 illustrates a double-ended instrument showing the handle in cross-section.

### DESCRIPTION OF EXAMPLES

Three different devices are illustrated in the drawings. Devices 10 and 10a differ only in that their faces are aligned at right angles to one another. Device 10b illustrates a slightly different face shape. The devices are used to pack composite, amalgam or other restorative dental materials that are used to fill a dental cavity preparation. The working ends of the devices have a flat face that allows the dentist to apply a uniform force over a relatively large area as compared to a ball-shaped tip. This allows the restorative material to be packed more easily and quickly while still accomplishing the necessary complete fill, and a desirable density and uniformity. The faces have a generally oval shape that defines opposed relatively narrow ends that can be pointed or slightly rounded. The narrow ends fit well into the corners that are created between the axial wall of the preparation and the matrix band of an interproximal cavity preparation. The result is that the restorative material can be more easily packed into these locations without voids or open margins, which leads to better restorations with less chance of the restorations causing discomfort or leading to further tooth decay.

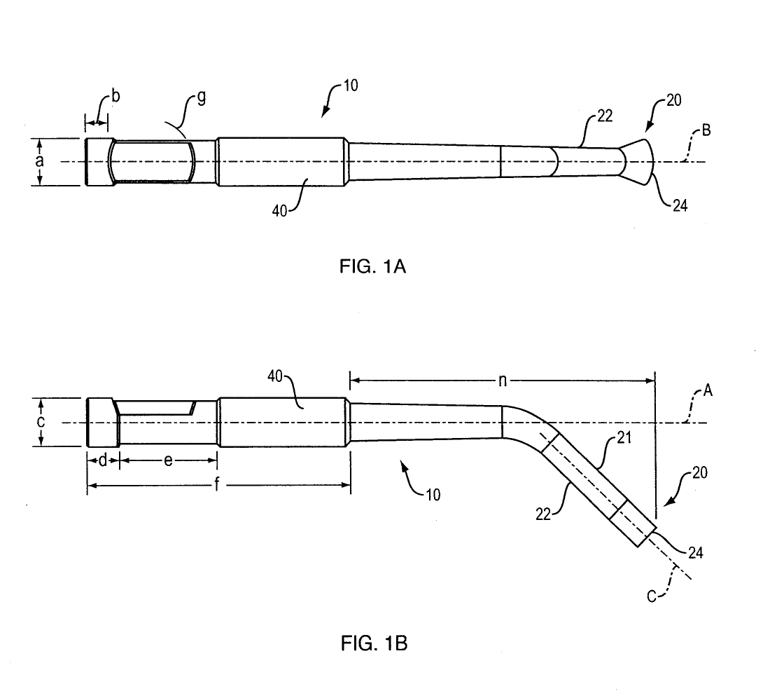

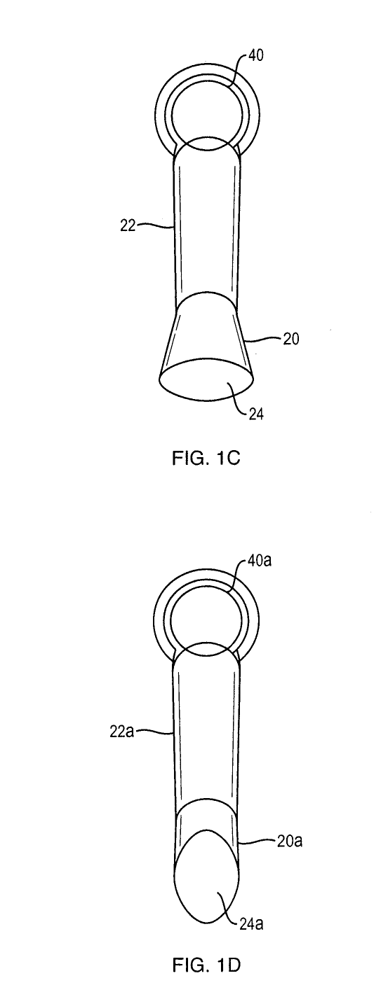

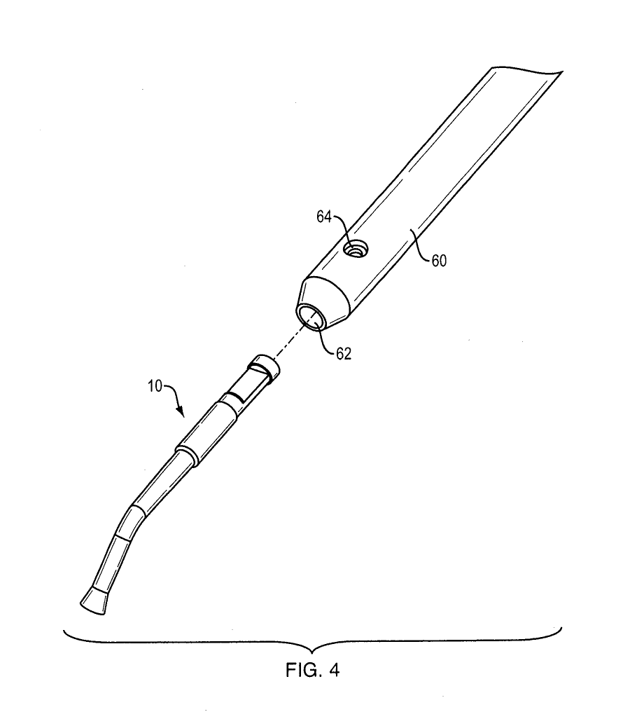

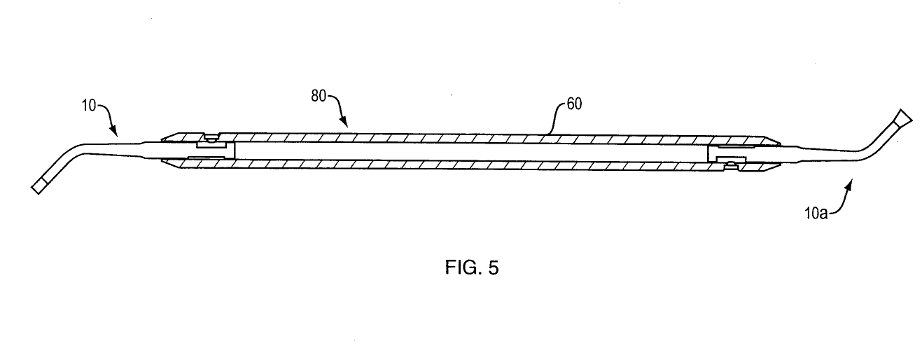

First device 10 and second device 10a are shown in the drawings. Each device has a working end, 20, 20a, respectively. Each working end defines a flat distal face 24, 24a. The faces have identical shapes but are oriented (when the devices are coupled to a handle as shown in FIG. 5) perpendicularly to one another. Thus, the preferred example of instrument 80, FIG. 5, has two ends 20 and 20a that have the same face shape, but with the faces perpendicular to each other on the B-axis (see FIGS. 1C, 1D and 4). The two ends are 180° from each other on the A-axis (FIG. 1B and FIG. 5). This allows for ease of application by either right or left-handed dentists in any of the four posterior quadrants of the oral cavity (Upper Right [UR], Upper Left [UL], Lower Right [LR] or Lower Left [LL]).

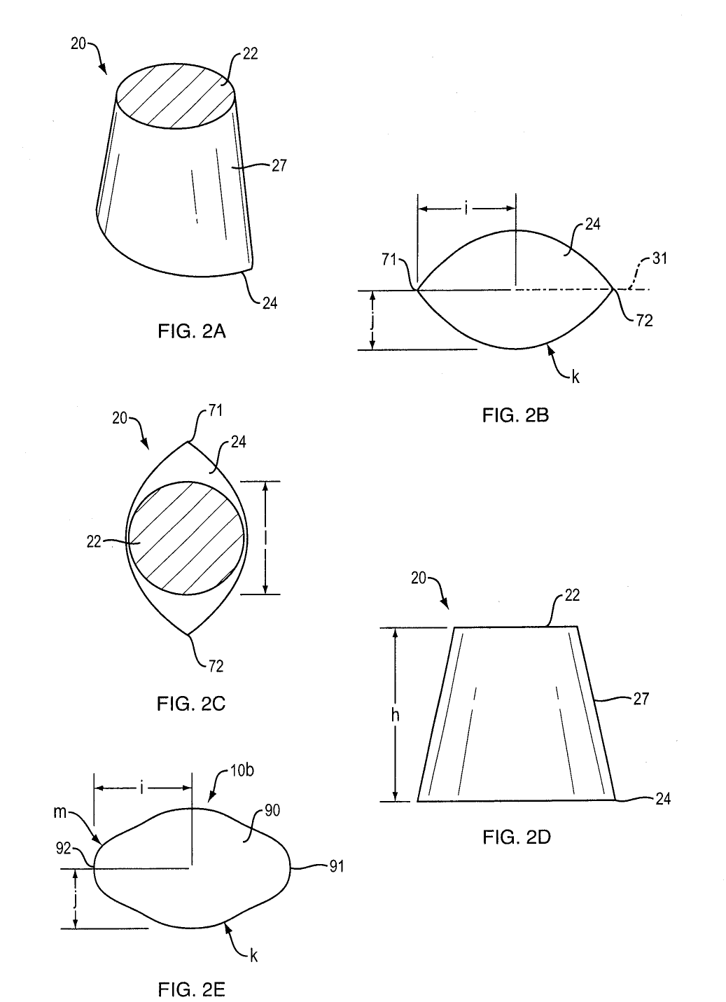

FIG. 1A is a top view, FIG. 1B a side view and FIG. 1C is an end view looking at end 20. FIG. 1D shows end 20a with face 24a that is perpendicular to face 24 of end 20. FIGS. 2A-2D show working end 20 and 20a wherein circular shaft portion 22 and 22a smoothly flares outward over a flared transition portion 27 to flat face 24 and 24a, respectively. Face 24 and 24a defines a generally oval shape with either rounded or pointed narrow ends; pointed ends 71 and 72 are shown in all figures except FIG. 2E which shows slightly rounded narrow ends 91 and 92 of an alternative example. FIG. 2A is a perspective view, FIG. 2B an end view, FIG. 2C a top view and FIG. 2D a side view. FIG. 4 and FIG. 5 show one manner in which the device can be coupled to a standard dental instrument handle. FIG. 5 is a cross-section through the B-axis.

A double-ended dental composite condensing instrument has two operative ends, 20 and 20a. Each working end has a pointed oval face 24, 24a. The devices also have an affixing end 40 that is adapted to be mechanically coupled to standard handle 60. The affixing end can be configured for the different methods of attaching the operative end to the handle, whether it be by screw, pin, press fit, glue or other methods known to the instrument maker. FIGS. 1, 4 and 5 show a configuration for the use of a screw as the attachment means. Modifications to the design of the affixing end 40 would be made to accommodate other attachment methods. The angled portion 21 is in line with the B-axis. In a double-ended instrument the angled portion on each end is preferred to be at 180° relationship to each other around the B-axis. The preferred angle of the angled portion 21 (i.e., angle between axes A and C) is 45° to the A-axis. One of the pointed oval faces 24, 24a of the operative ends 10, 10a has its narrow end points 71, 72 in line with the A-axis, while the other end has its narrow end points in line with the B-axis, thereby making the faces perpendicular to each other. Stated another way, each face 24, 24a has its narrow ends aligned along a longitudinal axis, and the axes of the two faces are perpendicular. For example, pointed ends 71 and 72 lie along longitudinal axis 31 of face 24, FIG. 2B, while the points at the narrow ends of face 24a (not numbered) lie along a face longitudinal axis that is perpendicular to axis 31.

In one set of examples the end faces 24, 24a are each about 2.5 mm long (e.g., 2.62 mm long), about 1.5 mm wide (e.g., 1.62 mm wide) and each defines curves along their long sides having radii of curvature of about 1 mm (e.g., 1.1 mm). Shaft 22 can be about 1.5 mm in diameter (e.g., 1.57 mm). In non-limiting examples these dimensions can be varied plus or minus up to about 0.4 mm over these dimensions. Of course, a single-ended instrument would only have one operative end, and the end could be in either of the orientations described above. Approximate dimensions depicted in the drawings, which are illustrative of the examples but are not limiting of the scope of the disclosure herein, are set forth in Table 1 below.

TABLE 1

| Dimension | Size (mm) |
|---|---|
| a | 2.8 |
| b | 1.5 |
| c | 2.5 |
| d | 1.85 |
| e | 6.05 |
| f | 16.05 |
| g | 2.5 |
| h | 2.35 |
| i | 1.31 |
| j | 0.81 |
| k | 1.1 (radius of curvature. |
| | Two places.) |
| l | 1.57 |
| m | 0.45 (radius of curvature. |
| | Two places.) |
| n | 18.5 |

A double-ended instrument as described above gives the clinician the ability, whether left-handed or right-handed, to access all areas of the mouth and to condense the restorative material in the cavity preparation, reaching the gingival floor and axial walls, and avoiding voids and open margins in the final restoration.

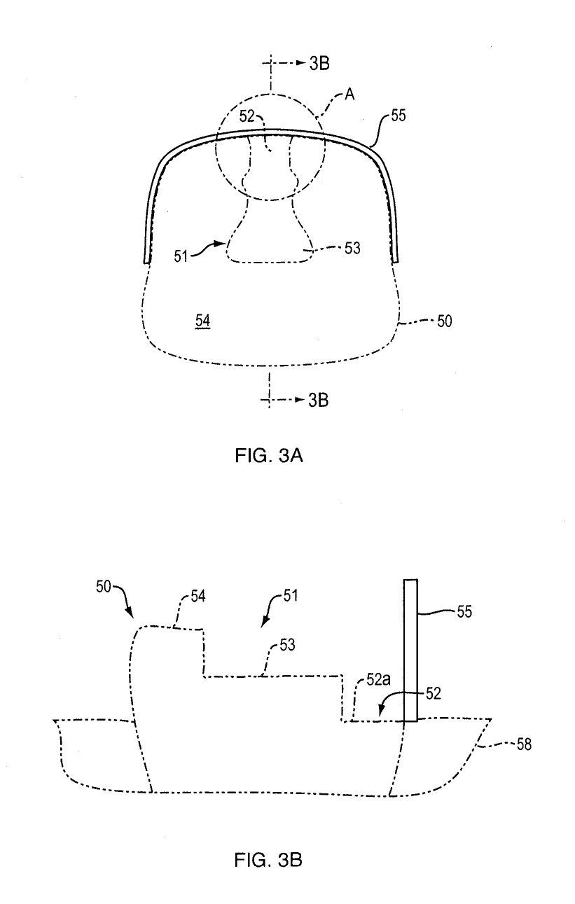

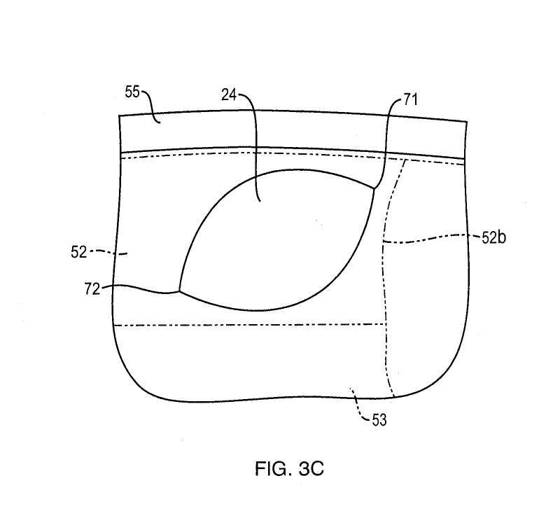

Operative end 10 is shown in FIG. 3C in use condensing restorative dental material (not shown for the sake of clarity) in an interproximal cavity preparation. Tooth 50 has been prepared by creating interproximal cavity preparation 51. Cavity preparation 51 includes a relatively shallow portion 53 located above the pulp, and a deeper portion 52 along the periphery of the tooth. Portion 52 defines gingival floor 52a that is at the approximate level of gum 58, and vertical axial walls 52b. Matrix band 55 is shown in place around the periphery of tooth 50. The wedge that would typically be present is not shown

Deep portion 52 is typically very small—perhaps 1-2 mm wide. Also, the intersection of axial walls 52b and matrix band 55 forms relatively sharp angles, an approximately 90 degree angle shown in FIG. 3C. The sizes, shapes and angles present in the interproximal preparation create small, irregular and difficult to reach volumes that are difficult to fully fill with restorative material. The subject instrument carries a small working end with flat face 24 and pointed ends 71 and 72. The working end has a width and length that are small enough such that the end fits into portion 52; this allows the dentist to pack the material down against gingival floor 52a. Point 71 also fits well into the corner between wall 52b and band 55; this allows the dentist to fill the corner simply by aligning the point with the corner and pushing the instrument downward in the normal fashion. The size of the face and its shape thus allow the dentist to fully pack an interproximal cavity preparation using essentially the same technique and motions that the dentist would use to pack a preparation that did not reach the periphery of the tooth.

The claims are not limited to the described examples. Rather, they encompass other constructions and uses of the device. For example, the periphery of the generally flat face could take other generally geometric or more irregular shapes. Generally, the face should define at least one narrow portion or end that can fit at least part of the way into tight corners created where a matrix band meets an axial wall of an interproximal cavity preparation. Other examples will occur to those skilled in the field and are within the scope of the claims.

What is claimed is:

1. A dental instrument, comprising:
a first shaft; and
a first operative end that defines a generally flat face and a relatively narrow portion of the face.

2. The dental instrument of claim 1 wherein the face has a generally oval shape with opposite narrow ends.

3. The dental instrument of claim 2 wherein the narrow ends of the face are generally pointed.

4. The dental instrument of claim 3 wherein the face is about 2.5 mm long from pointed end to pointed end, and is about 1.5 mm wide.

5. The dental instrument of claim 4 wherein along opposite sides between the pointed ends the perimeter of the face has a radius of curvature of about 1 mm.

6. The dental instrument of claim 2 wherein the first shaft has a generally circular cross-sectional shape, and further comprising an integral transitional section that smoothly flares outward and transitions into the operative end.

7. The dental instrument of claim 2 wherein the first shaft is constructed and arranged to be coupled to a handle.

8. The dental instrument of claim 7 further comprising a second shaft and a second operative end that defines a generally flat face that has a generally oval shape with opposite narrow ends.

9. The dental instrument of claim 8 wherein the first and second operative ends each define a longitudinal axis, and the narrow ends of each face lie along these longitudinal axes.

10. The dental instrument of claim 9 wherein the two longitudinal axes are transverse to each other.

11. The dental instrument of claim 10 wherein the two longitudinal axes are perpendicular to each other.

12. A dental instrument that is constructed and arranged to be used along with a handle, comprising:
a first shaft that is constructed and arranged to be coupled to a handle and that has a generally circular cross-sectional shape and comprises an integral transitional section that smoothly flares outward and transitions into a first operative end that defines a generally flat first face, wherein the first face has a generally oval shape with opposite narrow ends that are generally pointed; and
a second shaft that is constructed and arranged to be coupled to a handle and that has a generally circular cross-sectional shape and comprises an integral transitional section that smoothly flares outward and transitions into a second operative end that defines a generally flat second face, wherein the second face has a generally oval shape with opposite narrow ends that are generally pointed;
wherein the first and second operative ends each define a longitudinal axis, the narrow ends of each face lie along these longitudinal axes, and the axes are essentially perpendicular to each other.

13. The dental instrument of claim 12 wherein each face is about 2.5 mm long from pointed end to pointed end and about 1.5 mm wide, and along opposite sides between the pointed ends the perimeter of each face has a radius of curvature of about 1 mm.
